(19) United States
(12) Patent Application Publication
(10) Pub. No.: US 2019/0018173 A1
(43) Pub. Date: Jan. 17, 2019

(54) COMPOSITION FOR NEAR INFRARED LIGHT-ABSORBING FILMS, OPTICAL FILTERS, CAMERA MODULES AND ELECTRONIC DEVICES

(71) Applicant: Samsung Electronics Co., Ltd., Suwon-si (KR)

(72) Inventors: Hyung Jun KIM, Suwon-si (KR); Changki KIM, Suwon-si (KR); Jong Hoon WON, Yongin-si (KR); Yong Joo LEE, Suwon-si (KR); Myungsup JUNG, Seongnam-si (KR)

(73) Assignee: Samsung Electronics Co., Ltd., Suwon-si (KR)

(21) Appl. No.: 15/804,477

(22) Filed: Nov. 6, 2017

(30) Foreign Application Priority Data
Jul. 12, 2017 (KR) 10-2017-0088430

(51) Int. Cl. G02B 5/20

(52) U.S. Cl. CPC G02B 5/208; G02B 7/021

(57) ABSTRACT

A composition for a near infrared light-absorbing film includes a solid-phase first copper phosphate ester compound, and a liquid-phase second copper phosphate ester compound, wherein at least one part of the first copper phosphate ester compound is dissolved in the second copper phosphate ester compound, and the second copper phosphate ester compound is non-volatile in a temperature region of about 20° C. to about 300° C. The composition may be included in an optical filter, a camera module, and an electronic device.

### CROSS-REFERENCE TO RELATED APPLICATIONS

This application claims priority to and the benefit of, under 35 U.S.C. § 119, Korean Patent Application No. 10-2017-0088430 filed in the Korean Intellectual Property Office on Jul. 12, 2017, the entire contents of which are incorporated herein by reference.

### BACKGROUND

### 1. Field

A composition for near infrared light-absorbing film, optical filters, camera modules, and electronic devices are disclosed.

### 2. Description of the Related Art

Recently, electronic devices including image sensors that store an image as an electrical signal, such as cell phones, digital cameras, camcorders and cameras, have been widely used.

An electronic device may include an optical filter, so that the electronic device is configured to reduce or prevent generation of an optical distortion by light in the other regions than a particular visible wavelength spectrum of light.

### SUMMARY

Some example embodiments include a composition for a near infrared light-absorbing film that has improved coating reliability during film formation and does not cause damage of a substrate and an optical filter including the same.

Some example embodiments include a camera module and an electronic device including the optical filter.

According to some example embodiments, a composition for a near infrared light-absorbing film may include a solid-phase first copper phosphate ester compound, and a liquid-phase second copper phosphate ester compound. At least one part of the first copper phosphate ester compound is dissolved in the second copper phosphate ester compound. The second copper phosphate ester compound may be non-volatile in a temperature region of about 20° C. to about 300° C.

A weight ratio of the first copper phosphate ester compound relative to the second copper phosphate ester compound may be about 0.1 to about 2.5.

The second copper phosphate ester compound may include a cross-linkable monomer having thermal polymerizability or photo-polymerizability, and the second copper phosphate ester compound may further include a copper ion.

The composition for the near infrared light-absorbing film may further include a photoinitiator, and the cross-linkable monomer that is included in the second copper phosphate ester compound may have photo-polymerizability.

The first copper phosphate ester compound may be represented by Chemical Formula 1:

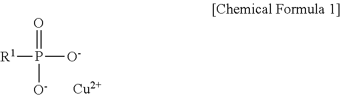

wherein, in Chemical Formula 1, R¹ is represented by Chemical Formula 2,

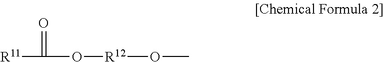

wherein, in Chemical Formula 2, R¹¹ is one of a C1 to C20 substituted or unsubstituted linear or branched alkyl group, a C1 to C20 substituted or unsubstituted linear or branched alkylene group, and R¹² is a substituted or unsubstituted C1 to C20 alkylene group.

The second copper phosphate ester compound may be represented by Chemical Formula 3:

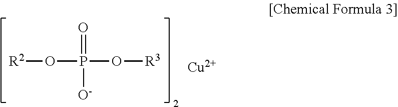

wherein, in Chemical Formula 3, R² and R³ are independently Chemical Formula 2,

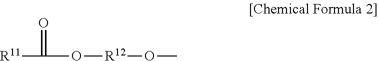

wherein, in Chemical Formula 2, R¹¹ is one of a C1 to C20 substituted or unsubstituted linear or branched alkyl group, a C1 to C20 substituted or unsubstituted linear or branched alkylene group and R¹² is a substituted or unsubstituted C1 to C20 alkylene group.

The composition may further include a multi-functional polymerizable cross-linkable monomer having thermal polymerizability or photo-polymerizability.

The multi-functional polymerizable cross-linkable monomer may include at least one material of a multi-functional acryl-based monomer, and a multi-functional epoxy-based monomer.

According to some example embodiments, an optical filter may include a transparent substrate and a near infrared light-absorbing film on the transparent substrate. The near infrared light-absorbing film may include the composition described above.

The near infrared light-absorbing film may be formed based on coating the composition on the transparent substrate and polymerizing at least one compound of the first copper phosphate ester compound and the second copper phosphate ester compound.

The optical filter may be associated with an average light transmittance of greater than or equal to about 70% in a wavelength spectrum of light of 430 nm to 700 nm.

The optical filter may be associated with an average light transmittance of less than or equal to about 30% in a wavelength spectrum of light of 700 nm to 1000 nm.

The optical filter may be associated with an average light transmittance of less than about 50% in a wavelength spectrum of light of 1000 nm to 1200 nm.

The transparent substrate may include at least one material of glass, polyethylene terephthalate, polyethylene naphthalate, triacetyl cellulose, polycarbonate, a cycloolefin polymer, poly(meth)acrylate, polyimide, and polystyrene.

The optical filter may include an infrared ray blocking layer on at least one surface of at least one element of the transparent substrate and the near infrared light-absorbing film.

According to some example embodiments, a camera device may include a lens, an image sensor, and the optical filter described above between the lens and the image sensor.

An electronic device may include the optical filter described above.

### BRIEF DESCRIPTION OF THE DRAWINGS

FIG. 1 is a schematic cross-sectional view showing an optical filter according to some example embodiments,

FIG. 2 is a schematic cross-sectional view showing an optical filter according to some example embodiments,

FIG. 3 is a schematic view showing a camera module according to some example embodiments,

FIG. 4 is a top plan view showing an organic CMOS image sensor as an image sensor according to some example embodiments,

FIG. 5 is a cross-sectional view showing one example of the organic CMOS image sensor of FIG. 4 along cross-sectional line V-V′ of FIG. 4, and

FIG. 6 is a graph showing light transmittances versus wavelengths of Examples and Comparative Examples according to some example embodiments.

### DETAILED DESCRIPTION

As used herein, when specific definition is not otherwise provided, “alkyl group” refers to a C1 to C20 alkyl group and “alkylene group” refers to a C1 to C20 alkylene group.

As used herein, when specific definition is not otherwise provided, “substituted” refers to replacement of at least one hydrogen by a substituent selected from a halogen atom (F, C1, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when a definition is not otherwise provided, in chemical formulae, hydrogen is bonded at the position when a chemical bond is not drawn where supposed to be given.

As used herein, an average light transmittance refers to an average value of light transmittances measured when incident light is radiated in a vertical direction (a front side direction) of an optical filter.

Hereinafter, example embodiments will be described in detail so that a person skilled in the art would understand the same. This disclosure may, however, be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a composition for a near infrared light-absorbing film according to some example embodiments is described.

A composition for near infrared light-absorbing film according to some example embodiments includes a solid-phased first copper phosphate ester compound and a liquid-phased second copper phosphate ester compound, wherein at least one part of the first copper phosphate ester compound is dissolved in the second copper phosphate ester compound.

In some example embodiments, the phases of the first and second copper phosphate ester compounds are respectively based on room temperature but are not necessarily limited thereto and may be for example based on a temperature ranging from about 0° C. to about 300° C., for example about 10° C. to about 300° C., for example about 20° C. to about 300° C., and for example about 25° C. to about 300° C. at least during an entire process of forming a near infrared ray absorbing film (e.g., when a known volatile solvent is used, a process of drying the volatile solvent is included).

In general, a near infrared ray absorbing film is formed by coating and drying a composition conventionally including an organo-metal composite dye capable of securing a larger near infrared ray absorption region than an organic dye including no metal such as copper sulfonate salt, copper phosphate salt, or the like as a near infrared ray absorption material.

The conventional organo-metal composite dye is used by being generally dissolved in a volatile solvent, for example, water, a polar or non-polar organic solvent, and the like. However, the organo-metal composite dye has no sufficient solubility about a conventional solvent, and the solvent may do damage on the surface of a substrate on which a film is supposed to be formed. In addition, a drying process for removing the solvent is necessarily required but may make the near infrared ray absorbing film curled, waved, pored, and the like. As a result, the organo-metal composite dye and the volatile solvent may deteriorate coating reliability of the near infrared ray absorbing film.

On the contrary, some example embodiments provide a composition for a near infrared light-absorbing film prepared by dissolving a solid-phase first copper phosphate ester compound capable of securing a near infrared ray absorption over a large area in a liquid-phase second copper phosphate ester compound. As referred to herein, a “solid-phase” or “solid-phased” compound refers to a compound that is in a solid phase (e.g., is a solid) at room temperature. As further referred to herein, a “liquid-phase” or “liquid-phased” compound refers to a compound that is in a liquid phase (e.g., is a liquid) at room temperature. As further referred to herein, “room temperature” refers to any temperature within a temperature range of about 15° C. to about 25° C., at ambient pressure (e.g., about 1 atmosphere). When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The second copper phosphate ester compound has non-volatility (e.g., “is non-volatile,” “is configured to not evaporate,” etc.) in a temperature region of about 20° C. to about 300° C. In other words, the second copper phosphate ester compound included in the composition for a near infrared light-absorbing film according to some example embodiments functions like the conventional solvent but is non-volatile unlike the conventional solvent over an entire temperature region of the coating and drying process of the organo-metal composite dye.

Accordingly, the composition for a near infrared light-absorbing film according to some example embodiments may be a liquid composition having a little higher viscosity than a conventional composition including the organo-metal composite dye and the volatile solvent.

In addition, the composition for a near infrared light-absorbing film may include the first and second copper phosphate ester compounds in a weight ratio of the first copper phosphate ester compound relative to the second copper phosphate ester compound, for example greater than or equal to about 0.1, for example greater than or equal to about 0.5, for example greater than or equal to about 1.0, and for example less than or equal to about 2.5, for example less than or equal to about 2.0, for example less than or equal to about 1.5.

When the weight ratio of the first copper phosphate ester compound relative to the second copper phosphate ester compound is less than about 0.1, the first copper phosphate ester compound is used in too a small amount, and thus near infrared ray absorption capability by copper may be deteriorated. On the other hand, when a weight ratio of the first copper phosphate ester compound relative to the second copper phosphate ester compound is greater than about 2.5, the first copper phosphate ester compound may not be uniformly dissolved in the second copper phosphate ester compound and thus nonuniformly dispersed therein.

Accordingly, the composition for a near infrared light-absorbing film according to some example embodiments may be prepared by adjusting the weight ratio of the first copper phosphate ester compound relative to the second copper phosphate ester compound as described above, so that the second copper phosphate ester compound may function as a solvent about the first copper phosphate ester compound.

According to some example embodiments, the second copper phosphate ester compound includes a cross-linkable monomer having (“associated with,” “including,” etc.) thermal polymerizability or photo-polymerizability. The second copper phosphate ester compound may further include a copper ion. In some example embodiments, the second copper phosphate ester compound may be a complex compound formed by (“at least partially comprising”) the cross-linkable monomers having thermal polymerizability or photo-polymerizability with the copper ion.

In other words, the second copper phosphate ester compound is a near infrared ray absorption material capable of (“configured to”) supplementing near infrared ray absorption capability of the first copper phosphate ester compound as well as functions as a solvent about the first copper phosphate ester compound and in addition, has a polymerizable reactor and thus is a material for a polymerization for forming a film.

In some example embodiments, since the cross-linkable monomers have photo-polymerizability, the composition for a near infrared light-absorbing film may further include an additive, for example, a photoinitiator and the like to improve a photopolymerization among the cross-linkable monomers. However, the example embodiments are not necessarily limited thereto, and when the cross-linkable monomers may have thermally polymerizability, an additive such as a polymer binder, a surfactant, an antioxidant, and the like may be further included.

The first copper phosphate ester compound according to some example embodiments is a solid-phased compound as described above and functions as a dye having near infrared ray absorption capability as described above. In addition, the first copper phosphate ester compound has a polymerizable reactor and thus is a material for a polymerization for forming a film.

The first copper phosphate ester compound may be for example represented by Chemical Formula 1.

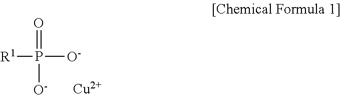

In Chemical Formula 1,

R¹ is represented by Chemical Formula 2.

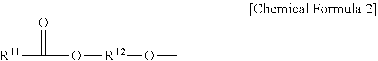

In Chemical Formula 2, R¹¹ is one of a C1 to C20 substituted or unsubstituted linear or branched alkyl group, a C1 to C20 substituted or unsubstituted linear or branched alkylene group and R¹² is a substituted or unsubstituted C1 to C20 alkylene group.

In Chemical Formula 1, copper divalent ions are respectively combined with each oxygen ion and form a copper complex compound.

The first copper phosphate ester compound according to some example embodiments includes the compound represented by Chemical Formula 1 or a combination thereof. Accordingly, an optical distortion in a near infrared ray wavelength spectrum of light may be effectively reduced or prevented by absorbing light over a wide region belonging to the near infrared ray wavelength spectrum of light.

However, the first copper phosphate ester compound according to some example embodiments is not necessarily limited to Chemical Formula 1 and may further include at least one of various copper phosphate ester compounds not belonging to Chemical Formula 1 but having a solid-phase (e.g., being solid) depending on required near infrared ray absorption capability.

On the other hand, the second copper phosphate ester compound according to some example embodiments is a compound having a liquid phase as described above and functions as a solvent about the first copper phosphate ester compound and simultaneously, as a dye having near infrared ray absorption capability.

The second copper phosphate ester compound according to some example embodiments may be for example represented by Chemical Formula 3.

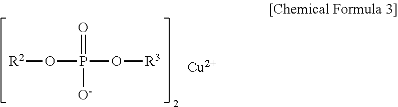

In Chemical Formula 3,

R² and R³ are independently Chemical Formula 2.

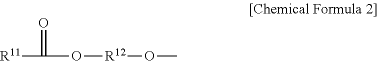

In Chemical Formula 2, R¹¹ is one of a C1 to C20 substituted or unsubstituted linear or branched alkyl group, a C1 to C20 substituted or unsubstituted linear or branched alkylene group and R¹² is a substituted or unsubstituted C1 to C20 alkylene group.

In Chemical Formula 3, copper divalent ions are respectively combined with each oxygen ion inside a pair of phosphoric acid ester group and form a copper complex compound.

The second copper phosphate ester compound according to some example embodiments may include one kind or two kinds (“types”) of compound belonging to Chemical Formula 3.

The composition for the near infrared light-absorbing film according to some example embodiments may further include a multi-functional polymerizable cross-linkable monomer having thermal polymerizability or photo-polymerizability. Examples of the multi-functional polymerizable cross-linkable monomer according to some example embodiments may include at least one material of a multi-functional acryl-based monomer, and a multi-functional epoxy-based monomer. The multi-functional polymerizable cross-linkable monomer may increase cross-linking among the first copper phosphate ester compounds and second copper phosphate ester compounds and/or between the first copper phosphate ester compound and the second copper phosphate ester compound in the composition for a near infrared light-absorbing film and thus improve overall polymerization efficiency during the polymerization reaction.

As described above, the composition for the near infrared light-absorbing film according to some example embodiments uses the first copper phosphate ester compound having near infrared ray absorption capability as a solute and the second copper phosphate ester compound as a solvent instead of dissolving a conventional organo-metal composite dye in a volatile solvent. Accordingly, a drying process for removing the solvent may be omitted unlike a conventional composition, and thus deterioration of coating reliability of a film which may be caused by the conventional solvent may be improved.

Hereinafter, an optical filter according to some example embodiments, that is, an optical filter including a near infrared ray absorbing film formed by using the composition is illustrated with a reference to drawings.

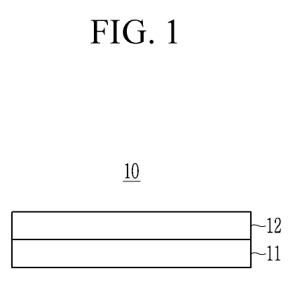

FIG. 1 is a schematic cross-sectional view showing an optical filter according to some example embodiments.

Referring to FIG. 1, an optical filter 10 according to some example embodiments includes a transparent substrate 11 and a near infrared ray absorbing film 12 (“near infrared light-absorbing film”) on the transparent substrate.

The transparent substrate 11 may comprise an optically transparent material, and may have for example an average light transmittance of greater than or equal to about 80%, greater than or equal to about 85%, or greater than or equal to about 90% in a wavelength spectrum of light. Herein, the wavelength spectrum of light may be for example a wavelength spectrum of light of greater than about 380 nm and less than about 700 nm, and the average light transmittance is obtained by averaging light transmittance of incident light in a vertical direction (front side direction) of the transparent substrate 11.

The transparent substrate 11 may include for example at least one material of glass, polyethyleneterephthalate, polyethylenenaphthalate, triacetyl cellulose, polycarbonate, cycloolefin polymer, poly(meth)acrylate, polyimide, and polystyrene, but is not limited thereto.

The transparent substrate 11 may selectively absorb at least one part of light in an ultraviolet (UV) region. Ultraviolet (UV) absorption capability of the transparent substrate 11 may come from a material of the transparent substrate 11 itself, but the transparent substrate 11 having ultraviolet (UV) absorption capability may be formed by adding an ultraviolet (UV) absorber during formation of the transparent substrate 11. Herein, the ultraviolet (UV) region may be for example a wavelength spectrum of light of less than or equal to about 380 nm.

The transparent substrate 11 may absorb most of light in a wavelength spectrum of light of at least about 350 nm to about 380 nm, and thus an average light transmittance of the optical filter 10 in a wavelength spectrum of light of about 350 nm to 380 nm may be less than or equal to about 1%, for example less than or equal to about 0.8% or less than or equal to about 0.5%.

The transparent substrate 11 may include various additives according to required properties of the optical filter 10.

The transparent substrate 11 may have a thickness of about 20 μm to about 120 μm.

The near infrared ray absorbing film 12 may transmit light in a particular wavelength spectrum of light and selectively absorbs at least one wavelength spectrum of light in a near infrared wavelength spectrum. Herein the particular wavelength spectrum of light may be for example a wavelength spectrum of light of greater than about 380 nm and less than about 700 nm and the near infrared wavelength spectrum of light may be for example a wavelength spectrum of light of about 700 nm to about 1200 nm.

The near infrared ray absorbing film 12 may include a polymer of the first copper phosphate ester compound and the second copper phosphate ester compound, and may further include a polymer binder, a surfactant, an antioxidant, a photoinitiator, and the like. Thus, the near infrared ray absorbing film 12 may include the composition for the near infrared light-absorbing film, including the first copper phosphate ester compound and the second copper phosphate ester compound, as described above.

The near infrared ray absorbing film 12 may be obtained (“formed”) without a separate drying process as described above. In other words, the near infrared ray absorbing film 12 may be obtained (“formed”) by coating the composition for the near infrared light-absorbing film on the transparent substrate 11 and then, polymerizing at least one compound of the first copper phosphate ester compound, the second copper phosphate ester compound, or a combination thereof. In other words, the polymerization reaction may occur among the first copper phosphate ester compounds or the second copper phosphate ester compounds or between the first copper phosphate ester compound and the second copper phosphate ester compound. In addition, when the composition for the near infrared light-absorbing film further includes the cross-linkable monomer, the polymerization reaction may occur over each first copper phosphate ester compound, second copper phosphate ester compound, and cross-linkable monomer or among them.

The composition coated on the transparent substrate 11 may be optionally cured by heat and/or light and the coating may be for example spin coating, slit coating, bar coating, blade coating, slot die coating, and/or inkjet coating.

The near infrared ray absorbing film 12 may have for example a thickness of about 10 μm to about 200 μm.

The optical filter 10 has a structure where the transparent substrate 11 and the near infrared ray absorbing film 12 are sequentially stacked as described above and thereby light in a wavelength spectrum of light may be effectively transmitted and light in a near infrared wavelength spectrum of light may be effectively blocked. In addition, light in an ultraviolet (UV) wavelength spectrum of light may be effectively blocked by imparting an absorption function of light in an ultraviolet (UV) region to the transparent substrate 11. Accordingly, the optical filter 10 may effectively sense light in a particular visible wavelength spectrum of light in a sensor sensing light such as an image sensor by increasing purity of transmittance of light in a particular visible wavelength spectrum of light of light in all wavelength spectra of light and thus optical distortion by light besides a particular visible wavelength spectrum of light may be decreased or prevented.

The optical filter 10 may effectively transmit light in a particular visible wavelength spectrum of light and selectively block light in a near infrared wavelength spectrum of light by a combination of the transparent substrate 11 and the near infrared ray absorbing film 12.

For example, the optical filter 10 may have (“may be associated with”), for example an average light transmittance of greater than or equal to about 50%, for example greater than or equal to about 60%, or for example greater than or equal to about 70% in a wavelength spectrum of light of 430 nm to 700 nm, and average light transmittance of less than or equal to about 40%, for example less than or equal to about 30% in a wavelength spectrum of light of 700 nm to 1000 nm, and less than or equal to about 60%, for example less than or equal to about 50% in a wavelength spectrum of light of 1000 nm to 1200 nm. Herein, the average light transmittance refers to an average value of light transmittances measured when incident light is radiated in a vertical direction (a front side direction) of an optical filter 10.

For example, the optical filter 10 has high absorptivity and low light transmittance for a near infrared wavelength spectrum of light, and a relatively low absorption rate and high light transmittance for a mid-infrared wavelength spectrum of light and a far-infrared wavelength spectrum of light.

The optical filter 10 may have, for example a thickness of about 10 μm to about 200 μm. Within the thickness range, an infrared ray absorbing optical filter may be realized.

In this way, the optical filter 10 may selectively absorb light in a near infrared wavelength spectrum of light between a particular visible wavelength spectrum of light and an infrared wavelength spectrum of light in all wavelength spectra of light and blocks it, and thereby a cross or mixing of a signal by light in a particular visible wavelength spectrum of light and a signal by light in a non-visible wavelength spectrum of light may be prevented to decrease or prevent optical distortion such as a crosstalk.

In addition, the optical filter 10 may effectively absorb light in a near infrared wavelength spectrum of light regardless of an incidence direction, and thus effectively absorbs incident light in a near infrared wavelength spectrum of light from a side direction and blocks it, and thereby a distortion of a signal by light in a particular visible wavelength spectrum of light by incident light in a near infrared wavelength spectrum of light from a side may be decreased or prevented.

Hereinafter, an optical filter according to some example embodiments is described.

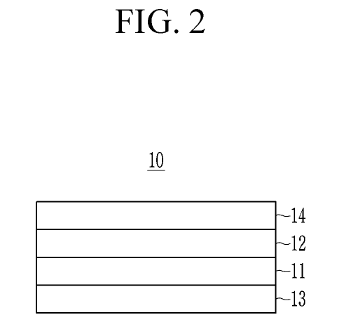

FIG. 2 is a schematic cross-sectional view showing an optical filter according to some example embodiments.

Referring to FIG. 2, an optical filter 10 according to some example embodiments includes a transparent substrate 11, a near infrared ray absorbing film 12, and infrared ray blocking layers 13 and 14.

The transparent substrate 11 and the near infrared ray absorbing film 12 are the same as described above.

In some example embodiments, including the example embodiments shown in FIG. 2, the optical filter 10 may include an infrared ray blocking layer 13 and/or 14 on at least one surface of at least one element of the transparent substrate 11 and a near infrared ray light-absorbing layer (“near infrared ray absorbing film 12”). The infrared ray blocking layers 13 and 14 may be disposed under the transparent substrate 11 and/or on the near infrared ray absorbing film 12. In the drawing, the infrared ray blocking layers 13 and 14 are illustrated but one of them may be omitted.

The infrared ray blocking layers 13 and 14 reflects light in an infrared wavelength spectrum of light effectively and thereby optical distortion by light in an infrared wavelength spectrum of light may be effectively decreased or prevented.

The infrared ray blocking layers 13 and 14 may reflect light in a part of a near infrared wavelength spectrum of light, a mid-infrared wavelength spectrum of light, and a far-infrared wavelength spectrum of light and may reflect for example light in a wavelength spectrum of light of about 700 nm to about 3 μm.

The infrared ray blocking layers 13 and 14 are not particularly limited as long as they reflect light in an infrared wavelength spectrum of light, and may be for example a high refractive index reflective layer, a reflective layer including a high refractive index nanoparticle, or a multilayer including a plurality of layers having different refractive indexes, but are not limited thereto.

For example, the infrared ray blocking layers 13 and 14 include a first layer and a second layer consisting materials having different refractive indexes, and may include a multilayer where the first layer and the second layer are alternately and repeatedly stacked.

The first layer and the second layer may be, for example a dielectric layer including an oxide layer, a nitride layer, an oxynitride layer, a sulfide layer, or a combination thereof, and for example the first layer may have a refractive index of less than about 1.7 and the second layer may have a refractive index of greater than or equal to about 1.7. Within the ranges, for example the first layer may have a refractive index of greater than or equal to about 1.1 and less than about 1.7 and the second layer may have a refractive index about 1.7 to about 2.7, or for example the first layer may have a refractive index of about 1.2 to about 1.6 and the second layer may have a refractive index of about 1.8 to about 2.5.

The first layer and the second layer may include any material having the refractive indexes within the ranges, and for example the first layer may include a silicon oxide, an aluminum oxide, or a combination thereof and the second layer may include titanium oxide, zinc oxide, indium oxide, zirconium oxide, or a combination thereof. The first layer and the second layer may be, for example a five-layered to 80-layered, for example 5-layered to 50-layered.

Thicknesses of the first layer and the second layer may be determined according to a refractive index and a reflection wavelength of each layer, for example each of the first layer may have a thickness of about 10 nm to about 700 nm and each of the second layer may have a thickness of about 30 nm to about 600 nm. Thicknesses of the first layer and the second layer may be the same or different.

The optical filter 10 may have, for example a thickness of about 10 μm to about 200 μm. Within the thickness range, an infrared ray absorbing optical filter may be realized.

An optical filter 10 according to some example embodiments includes the transparent substrate 11 and the near infrared ray absorbing film 12 like the above embodiment and may transmit light in a particular visible wavelength spectrum of light effectively and blocks light in a near infrared wavelength spectrum of light effectively. In addition, the optical filter 10 according to some example embodiments further includes infrared ray blocking layers 13 and 14 and reflect light in a mid-infrared wavelength spectrum of light and a far-infrared wavelength spectrum of light and block it effectively, and thereby may be used as an optical filter preventing transmission of light in all infrared wavelength spectra of light. Accordingly, it is applied to an electronic device and a distortion of an optical signal of a particular visible wavelength spectrum of light by light in an infrared wavelength spectrum of light may be may be decreased or prevented.

The optical filter 10 may be applied to all uses for filtering light in an infrared wavelength spectrum of light, and may be, for example applied to a camera module and an electronic device including the same. The electronic device may be a digital camera, a camcorder, a monitoring camera such as CCTV, an in-car camera, a medical camera, a cell phone having a built-in or external camera, a computer having a built-in or external camera, a laptop computer having a built-in or external camera, and the like but is not limited thereto.

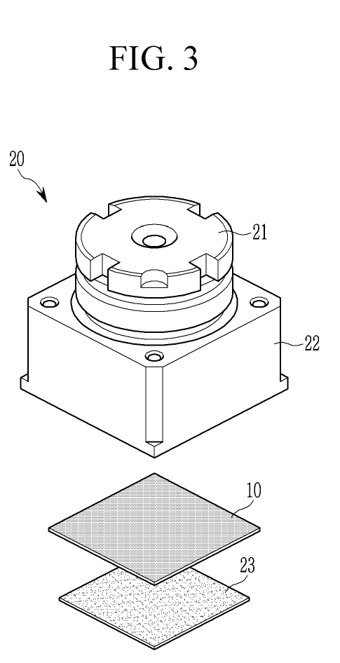

FIG. 3 is a schematic view showing a camera module according to some example embodiments.

Referring to FIG. 3, a camera module 20 (also referred to herein as a “camera device”) includes a lens barrel 21, a housing 22, an optical filter 10, and an image sensor 23. The optical filter 10 may be the optical filter shown in one or more of FIGS. 1-2.

The lens barrel 21 includes at least one lens imaging a subject, and the lens may be disposed along an optical axis direction. Herein, the optical axis direction may be a vertical direction of the lens barrel 21.

The lens barrel 21 is internally housed in the housing 22 and united with the housing 22. The lens barrel 21 may be moved in optical axis direction inside the housing 22 for autofocusing.

The housing 22 supports and houses the lens barrel 21 and may be open in the optical axis direction. Accordingly, incident light from one surface of the housing 22 may reach the image sensor 23 through the lens barrel 21 and the optical filter 10.

The housing 22 may be equipped with an actuator for moving the lens barrel 21 in the optical axis direction. The actuator may include a voice coil motor (VCM) including a magnet and a coil. However, various methods such as a mechanical driving system or a piezoelectric driving system using a piezoelectric device other than the actuator may be adopted.

The optical filter 10 may be the same as described above.

The image sensor 23 may concentrate an image of a subject and thus store it as data, and the stored data may be displayed as an image through a display media.

The image sensor 23 may be mounted in a substrate (not shown) and electrically connected with the substrate. The substrate may be, for example, a printed circuit board (PCB) or electrically connected to a printed circuit board (PCB), and the printed circuit (PCB) may be, for example, flexible printed circuit (FPCB).

The image sensor 23 concentrates light passing the lens barrel 21 and the optical filter 10 and generates a video signal and may be a complementary metal-oxide semiconductor (CMOS) image sensor and/or a charge coupled device (CCD) image sensor.

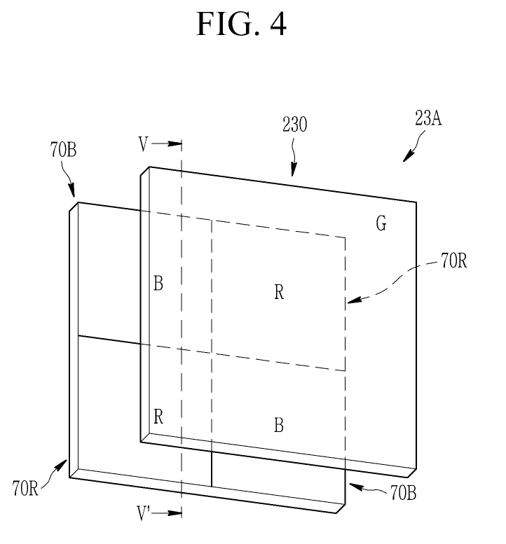

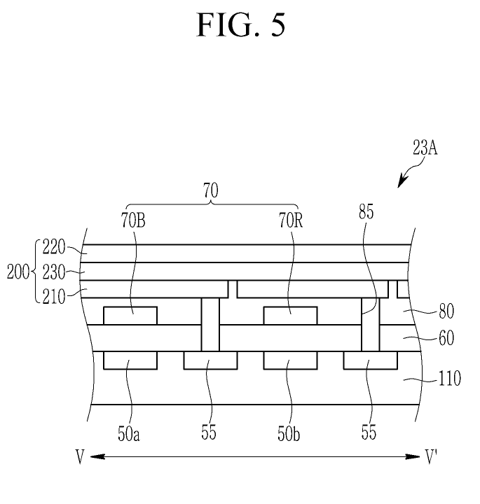

FIG. 4 is a top plan view showing an organic CMOS image sensor 23A as an image sensor according to some example embodiments and FIG. 5 is a cross-sectional view showing one example of the organic CMOS image sensor 23A of FIG. 4 along cross-sectional line V-V′ of FIG. 4. The image sensor 23A shown in FIGS. 4-5 may be the image sensor 23 shown in FIG. 3.

Referring to FIGS. 4 and 5, an organic CMOS image sensor 23A according to some example embodiments includes a semiconductor substrate 110 integrated with photo-sensing devices 50a and 50b, a transmission transistor (not shown), and a charge storage 55, a lower insulation layer 60, a color filter layer 70, a upper insulation layer 80, and an organic photoelectric device 200.

The semiconductor substrate 110 may be a silicon substrate, and is integrated with the photo-sensing devices 50a and 50b, the transmission transistor (not shown), and the charge storage 55. The photo-sensing devices 50a and 50b may be photodiodes.

The photo-sensing devices 50a and 50b, the transmission transistor, and/or the charge storage 55 may be integrated in each pixel, and for example as illustrated in drawings, the photo-sensing devices 50a and 50b may be included in a blue pixel and a red pixel and the charge storage 55 may be included in a green pixel.

The photo-sensing devices 50a and 50b sense light, the information sensed by the photo-sensing devices may be transferred by the transmission transistor, the charge storage 55 is electrically connected to the organic photoelectric device 100, and the information of the charge storage 55 may be transferred by the transmission transistor.

A metal wire (not shown) and a pad (not shown) are formed on the semiconductor substrate 110. In order to decrease signal delay, the metal wire and pad may be made of a metal having low resistivity, for example, aluminum (Al), copper (Cu), silver (Ag), and alloys thereof, but is not limited thereto. However, it is not limited to the structure, and the metal wire and pad may be disposed under the photo-sensing devices 50a and 50b.

The lower insulation layer 60 is formed on the metal wire and the pad. The lower insulation layer 60 may be made of an inorganic insulating material such as a silicon oxide and/or a silicon nitride, or a low dielectric constant (low K) material such as SiC, SiCOH, SiCO, and SiOF. The lower insulation layer 60 has a trench exposing the charge storage 55. The trench may be filled with fillers.

A color filter layer 70 is formed on the lower insulation layer 60. The color filter layer 70 includes a blue filter 70B formed in the blue pixel and a red filter 70R formed in the red pixel. In some example embodiments, a green filter is not included, but a green filter may be further included.

The upper insulation layer 80 is formed on the color filter layer 70. The upper insulation layer 80 eliminates a step caused by the color filter layer 70 and smoothes the surface. The upper insulation layer 80 and lower insulation layer 60 may include a contact hole (not shown) exposing a pad, and a through-hole 85 exposing the charge storage 55 of a green pixel.

The organic photoelectric device 200 is formed on the upper insulation layer 80. The organic photoelectric device 200 includes a lower electrode 210 and an upper electrode 220 facing each other and an absorbing layer 230 disposed between the lower electrode 210 and the upper electrode 220.

The lower electrode 210 and the upper electrode 220 may be all light-transmitting electrodes and the absorbing layer 230 (“absorption layer”) may selectively absorb light in a green wavelength spectrum of light and may replace a color filter of a green pixel.

As described above, the semiconductor substrate 110 and the organic photoelectric device 200 selectively absorbing light in a green wavelength spectrum of light have a stack structure and thereby the size of an image sensor may be reduced to realize a down-sized image sensor.

Focusing lens (not shown) may be further formed on the organic photoelectric device 200. The focusing lens may control a direction of incident light and gather the light in one region. The focusing lens may have a shape of, for example, a cylinder or a hemisphere, but is not limited thereto.

In FIGS. 4 and 5, a structure where the organic photoelectric device selectively absorbing light in a green wavelength spectrum of light is stacked on the semiconductor substrate 110 is illustrated, but the present disclosure is not limited thereto. An organic photoelectric device selectively absorbing light in a blue wavelength spectrum of light may be stacked on the semiconductor substrate 110 and a green photo-sensing device and a red photo-sensing device may be integrated in the semiconductor substrate 110 or an organic photoelectric device selectively absorbing light in a red wavelength spectrum of light may be stacked on the semiconductor substrate 110 and a green photo-sensing device and a blue photo-sensing device may be integrated in the semiconductor substrate 110.

Among the light in a particular visible wavelength spectrum of light passing the lens barrel 21 and the optical filter 10, light in a green wavelength spectrum of light may be mainly absorbed in the absorbing layer 30 and photoelectrically converted, and light in a blue wavelength spectrum of light and a red wavelength spectrum of light may pass the lower electrode 210 and be sensed by the photo-sensing devices 50a and 50b.

As described above, the optical filter 10 may effectively transmit light in a particular visible wavelength spectrum of light but absorb and block light in a near infrared wavelength spectrum of light and thus transfer pure light in a particular visible wavelength spectrum of light to an image sensor and resultantly, reduce or prevent a crosstalk generated when a signal by light in a particular visible wavelength spectrum of light and a signal by light in a non-visible wavelength spectrum of light are crossed and mixed in.

Hereinafter, the example embodiments are illustrated in more detail with reference to examples. However, these example embodiments are examples, and the present scope is not limited thereto.

### Manufacture of Optical Filter

### Example 1

A composition is prepared by using 100 parts by weight of a liquid compound represented by Chemical Formula B as a second copper phosphate ester compound, 2.5 parts by weight of dipentaerythritol hexa acrylate (DPHA) as a 6-functional acryl-based monomer, and 0.1 parts by weight of Irgacure 184 (BASF Corp.) as a photoinitiator based on 100 parts by weight of a solid-phased compound represented by Chemical Formula A as a first copper phosphate ester compound.

Chemical Formulae A and B are respectively as follows:

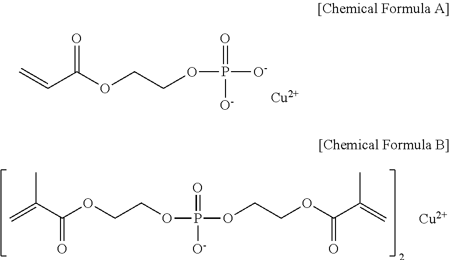

Subsequently, the composition is bar-coated on an 80 μm-thick triacetyl cellulose (TAC) film and photocured by an UV light with a dose of about 500 mJ to manufacture an optical filter having a near infrared ray absorbing film on the TAC film.

### Example 2

An optical filter having a near infrared ray absorbing film on a TAC film is manufactured according to the same method as Example 1 except for using a composition including 100 parts by weight of a solid-phased compound represented by Chemical Formula A as a first copper phosphate ester compound, 200 parts by weight of a liquid compound represented by Chemical Formula B as a second copper phosphate ester compound, 2.5 parts by weight of DPHA as a 6-functional acryl-based monomer, and 0.1 parts by weight of Irgacure184 (BASF Corp.) as a photoinitiator.

### Example 3

An optical filter having a near infrared ray absorbing film on a TAC film is manufactured according to the same method as Example 1 except for using a composition including 100 parts by weight of a solid-phased compound represented by Chemical Formula A as a first copper phosphate ester compound, 50 parts by weight of a liquid compound represented by Chemical Formula B as a second copper phosphate ester compound, 2.5 parts by weight of DPHA as a 6 functional acryl-based monomer, and 0.1 parts by weight of Irgacure184 (BASF Corp.) as a photoinitiator.

### Example 4

An optical filter is manufactured according to the same method as Example 1 except for forming the near infrared ray absorbing film on a glass substrate instead of the TAC film.

### Comparative Example 1

An optical filter having a near infrared ray absorbing film on a TAC film is manufactured according to the same method as Example 1 except for using 100 parts by weight of tetrahydrofuran (THF) instead of the second copper phosphate ester compound as a volatile solvent.

### Comparative Example 2

An optical filter having a near infrared ray absorbing film on a TAC film is manufactured according to the same method as Example 1 except for using 100 parts by weight of THF instead of the first copper phosphate ester compound as a volatile solvent.

### Comparative Example 3

An optical filter having a near infrared ray absorbing film on a glass substrate is manufactured according to the same method as Example 1 except for using 100 parts by weight of THF instead of the second copper phosphate ester compound as a volatile solvent and the glass substrate instead of the TAC film.

### Comparative Example 4

An optical filter having a near infrared ray absorbing film on a glass substrate is manufactured according to the same method as Example 1 except for using 100 parts by weight of THF instead of the first copper phosphate ester compound as a volatile solvent and the glass substrate instead of the TAC film.

### Comparative Example 5

An optical filter having a near infrared ray absorbing film on a TAC film is manufactured according to the same method as Example 1 except for using 1100 parts by weight of a second copper phosphate ester compound.

### Comparative Example 6

An optical filter having a near infrared ray absorbing film on a TAC film is manufactured according to the same method as Example 1 except for using 35 parts by weight of a second copper phosphate ester compound.

### Evaluation 1

Solubility of a near infrared ray absorption material in each composition prepared during manufacture of the optical filters according to Examples and Comparative Examples is measured, and the results are shown in Table 1.

Example 1 shows solubility of the first copper phosphate ester compound about the second copper phosphate ester compound, and Comparative Examples show solubility of the first copper phosphate ester compound about THF (Comparative Examples 1, 3, 5, and 6) and the second copper phosphate ester compound about THF (Comparative Examples 2 and 4).

The solubility is evaluated according to the following measurement reference with naked eyes.

⊚: completely dissolved without a non-dissolved material when examined with naked eyes

∘: a small amount of a non-dissolved material is left but may be filtered with a filter

X: a large amount of a non-dissolved material is left but may not be filtered with a filter

The filter is a syringe filter having a pore size of 0.2 μm.

TABLE 1

| | | | | | Comparative | Comparative | Comparative | Comparative | Comparative | Comparative |
|---|---|---|---|---|---|---|---|---|---|---|
| | Example 1 | Example 2 | Example 3 | Example 4 | Example 1 | Example 2 | Example 3 | Example 4 | Example 5 | Example 6 |
| Solubility | ⊚ | ⊚ | ◯ | ⊚ | ⊚ | ⊚ | ⊚ | ⊚ | ⊚ | X |

Referring to Table 1, Examples use no volatile solvent but show equivalent solubility to that of Comparative Examples using a volatile solvent (THF). In other words, Examples used no general volatile solvent but the second copper phosphate ester compound which well dissolves the first copper phosphate ester compound.

### Evaluation 2

A degree of haze of a substrate film generated by each composition during a process of manufacturing the optical filters according to Examples and Comparative Examples is shown in Table 2.

The haze of a substrate film may be generated when a composition coated on the substrate film has a chemical reaction with the surface of the substrate, mainly when the composition dissolves the surface of the substrate film. The degree of haze is evaluated with naked eyes according to the following evaluation reference.

⊚: no haze but transparent coating

X: haze is generated since the surface of a film is partly dissolved in a solvent

TABLE 2

| | | | | | Comparative | Comparative | Comparative | Comparative | Comparative | Comparative |
|---|---|---|---|---|---|---|---|---|---|---|
| | Example 1 | Example 2 | Example 3 | Example 4 | Example 1 | Example 2 | Example 3 | Example 4 | Example 5 | Example 6 |
| Haze | ⊚ | ⊚ | ⊚ | ⊚ | X | X | ⊚ | ⊚ | ⊚ | ND |

Referring to Table 2, as for Comparative Example 6, since the second copper phosphate ester compound is used in too small an amount and does not completely dissolves the first copper phosphate ester compound, appropriate coating quality is not secured, and thus evaluation data may not be obtained (ND, No data).

Referring to Table 2, Example 4 and Comparative Examples 3 and 4 turn out to form a film without haze by coating each composition on a glass substrate.

However, Examples 1 to 3 respectively coating the composition on a TAC film show no haze on the TAC film but form transparent films thereon, while Comparative Examples 1 and 2 respectively coating the compositions including a volatile solvent (THF) on a TAC film show haze.

In addition, Comparative Example 5 includes no volatile solvent unlike Comparative Examples 1 to 4 and forms a film without haze.

Accordingly, the compositions including no volatile solvent according to Examples show excellent chemical stability with a transparent substrate compared with the compositions according to Comparative Examples 1 to 4. Accordingly, the compositions according to Examples may be easily formed into each near infrared ray absorption layer on relatively thin various polymer substrates as well as a relatively thick glass substrate.

### Evaluation 3

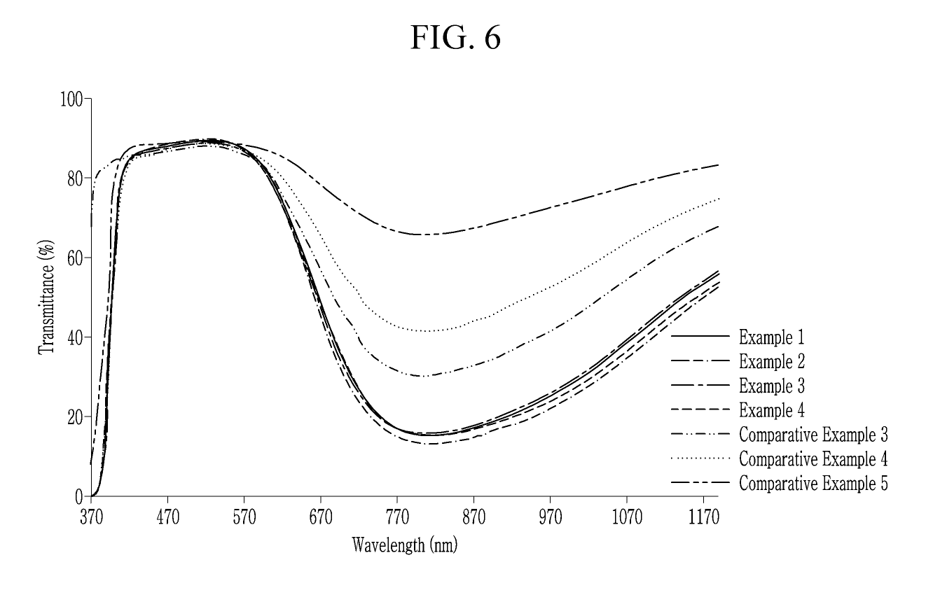

Light absorption characteristics of the optical filters according to Examples 1 to 4 and Comparative Examples 3 to 5 are evaluated and shown in FIG. 6. The light absorption characteristics are measured by using an UV-Vis spectrophotometer (SoldiSpec-3700, Shimadzu Corp.).

FIG. 6 is a graph showing light transmittances versus wavelengths of Examples and Comparative Examples according to some example embodiments.

In FIG. 6, the light absorption characteristics of the optical filters according to Comparative Examples 1 and 2 may not be measured, since the surface of a TAC film is dissolved by a volatile solvent, and the light absorption characteristics of the optical filter of Comparative Example 6 may not be measure by securing no appropriate coating quality, since the second copper phosphate ester compound is used in a very small amount and thus does not completely dissolve the first copper phosphate ester compound.

Referring to FIG. 6, the optical filters according to Examples show equivalent light transmittance in a wavelength spectrum of light but very low light transmittance in a near infrared wavelength spectrum of light compared with the optical filters according to Comparative Examples.

Particularly, when the first copper phosphate ester compound is only included (Comparative Example 3), the second copper phosphate ester compound is only included (Comparative Example 4), or the first and second copper phosphate ester compounds are used in a different weight ratio from those of Examples (Comparative Example 5), a near infrared ray absorption rate is very deteriorated compared with those of Examples.

While this disclosure has been described in connection with what is presently considered to be practical example embodiments, it is to be understood that the inventive concepts are not limited to the disclosed example embodiments, but, on the contrary, is intended to cover various modifications and equivalent arrangements included within the spirit and scope of the appended claims.

### DESCRIPTION OF SYMBOLS

| | |
|---|---|
| 10: optical filter | 11: transparent substrate |
| 12: near infrared ray absorbing film | 13, 14: infrared ray blocking |
| layer | |
| 20: camera module | 21: lens barrel |
| 22: housing | 23: image sensor |
| 23A: organic CMOS image sensor | 50a, 50b: photo-sensing device |
| 70: color filter layer | 60, 80: insulation layer |
| 200: organic photoelectric device | 210: lower electrode |
| 220: upper electrode | 230: absorbing layer |

What is claimed is:

1. A composition for a near infrared light-absorbing film, the composition comprising:
a solid-phase first copper phosphate ester compound; and
a liquid-phase second copper phosphate ester compound,
wherein at least one part of the first copper phosphate ester compound is dissolved in the second copper phosphate ester compound, and
wherein the second copper phosphate ester compound is non-volatile in a temperature region of about 20° C. to about 300° C.

2. The composition of claim 1, wherein a weight ratio of the first copper phosphate ester compound relative to the second copper phosphate ester compound is about 0.1 to about 2.5.

3. The composition of claim 1, wherein the second copper phosphate ester compound includes a cross-linkable monomer having thermal polymerizability or photo-polymerizability, and the second copper phosphate ester compound further includes a copper ion.

4. The composition of claim 3, wherein,
the composition for the near infrared light-absorbing film further includes a photoinitiator, and
the cross-linkable monomer that is included in the second copper phosphate ester compound has photo-polymerizability.

5. The composition claim 1, wherein the first copper phosphate ester compound is represented by Chemical Formula 1: 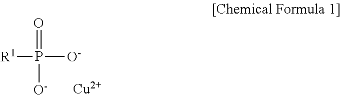
wherein, in Chemical Formula 1,
R¹ is represented by Chemical Formula 2, 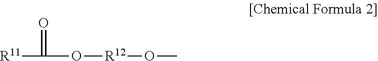
wherein, in Chemical Formula 2,
R¹¹ is one of a C1 to C20 substituted or unsubstituted linear or branched alkyl group, a C1 to C20 substituted or unsubstituted linear or branched alkylene group, and
R¹² is a substituted or unsubstituted C1 to C20 alkylene group.

6. The composition of claim 1, wherein the second copper phosphate ester compound is represented by Chemical Formula 3: 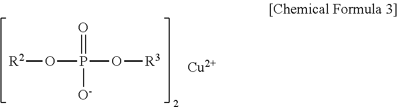
wherein, in Chemical Formula 3,
R² and R³ are independently Chemical Formula 2, 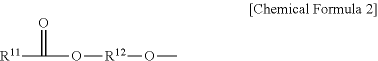
wherein, in Chemical Formula 2, R¹¹ is one of a C1 to C20 substituted or unsubstituted linear or branched alkyl group, a C1 to C20 substituted or unsubstituted linear or branched alkylene group and R¹² is a substituted or unsubstituted C1 to C20 alkylene group.

7. The composition of claim 1, wherein the composition further includes a multi-functional polymerizable cross-linkable monomer having thermal polymerizability or photo-polymerizability.

8. The composition of claim 7, wherein the multi-functional polymerizable cross-linkable monomer includes at least one material of a multi-functional acryl-based monomer, and a multi-functional epoxy-based monomer.

9. An optical filter, comprising:
a transparent substrate; and
a near infrared light-absorbing film on the transparent substrate, the near infrared light-absorbing film including the composition of claim 1.

10. The optical filter of claim 9, wherein the near infrared light-absorbing film is formed based on coating the composition on the transparent substrate and polymerizing at least one compound of the first copper phosphate ester compound and the second copper phosphate ester compound.

11. The optical filter of claim 9, wherein the optical filter is associated with an average light transmittance of greater than or equal to about 70% in a wavelength spectrum of light of 430 nm to 700 nm.

12. The optical filter of claim 9, wherein the optical filter is associated with an average light transmittance of less than or equal to about 30% in a wavelength spectrum of light of 700 nm to 1000 nm.

13. The optical filter of claim 9, wherein the optical filter is associated with an average light transmittance of less than about 50% in a wavelength spectrum of light of 1000 nm to 1200 nm.

14. The optical filter of claim 9, wherein the transparent substrate includes at least one material of glass, polyethylene terephthalate, polyethylene naphthalate, triacetyl cellulose, polycarbonate, a cycloolefin polymer, poly(meth)acrylate, polyimide, and polystyrene.

15. The optical filter of claim 9, wherein the optical filter includes an infrared ray blocking layer on at least one surface of at least one element of the transparent substrate and the near infrared light-absorbing film.

16. A camera device, comprising:
a lens;
an image sensor; and
the optical filter of claim 9 between the lens and the image sensor.

17. An electronic device, comprising the optical filter of claim 9.
